(19) United States
(12) Patent Application Publication
(10) Pub. No.: US 2026/0298258 A1
(43) Pub. Date: Oct. 1, 2026

(54) MULTI-BLADE CENTRIFUGAL AIR-SENDING DEVICE

(71) Applicant: Mitsubishi Electric Corporation, Tokyo (JP)

(72) Inventors: Hiroyasu HAYASHI, Tokyo (JP); Takuya TERAMOTO, Tokyo (JP); Yuto URABE, Tokyo (JP); Shota HOSOMI, Tokyo (JP); Yoshitaka AKARI, Saitama (JP); Yuta TAKAHASHI, Saitama (JP); Kazuo NYUI, Saitama (JP)

(21) Appl. No.: 18/880,395

(22) PCT Filed: Oct. 25, 2022
(86) PCT No.: PCT/JP2022/039681

§ 371 Date: Dec. 31, 2024

(30) Foreign Application Priority Data
Aug. 19, 2022 (JP) 2022-130868

(51) Int. Cl. F04D 29/42; F04D 29/30

(52) U.S. Cl. CPC F04D 29/4226; F04D 29/30

(57) ABSTRACT

A multi-blade centrifugal air-sending device has a fan that has a main plate, blades, and a side plate; and a scroll casing that has a peripheral wall and a side wall that has a bell mouth. The fan has a backward vane portion, a forward vane portion, and an inflection-point portion. The inflection-point portion is formed over an entire length of each of the blades. An entire portion of the inflection-point portion in an axial direction is further inside than an inner circumferential end portion of the bell mouth.

### TECHNICAL FIELD

The present disclosure relates to a multi-blade centrifugal air-sending device that has a scroll casing.

### BACKGROUND ART

Some multi-blade centrifugal air-sending device is provided with a fan that has a circular-disk-shaped main plate, a plurality of blades installed at the circumferential portion of the main plate, and a side plate to which end portions of the blades are fixed. Also, such a multi-blade centrifugal air-sending device is provided with a scroll casing that has a scroll-shaped peripheral wall that covers the fan and, to a suction port of the scroll casing, a bell mouth is provided that smoothly draws an airflow to the fan. Such a multi-blade centrifugal air-sending device often has, as its blades, forward vanes inclined in the direction of rotation of the fan to increase the pressure of an airflow that has flowed out from between the blades by the rotation of the fan through an enlarged air passage inside the scroll casing. However, the airflow drawn along the bell mouth into the scroll casing often flows toward the blades at an angle that does not correspond to the inlet angles of the forward vanes. Such a multi-blade centrifugal air-sending device may cause airflow separation on the suction surfaces of the leading edges and adjacent areas of the blades, which may result in a reduction in airflow. As a countermeasure, a multi-blade centrifugal air-sending device has been proposed that is provided with backward vanes, which face opposite to the direction of rotation of the fan, at the inner circumferences of the forward vanes. This structure thereby mitigates airflow reduction by smoothly guiding an airflow drawn from the bell mouth to the blades and preventing airflow separation generated on the suction surfaces of the leading edges and adjacent areas of the blades. Such a multi-blade centrifugal air-sending device is, for example, disclosed in Patent Literature 1.

### CITATION LIST

### Patent Literature

Patent Literature 1: Japanese Unexamined Patent Application Publication No. 2002-70793

### SUMMARY OF INVENTION

### Technical Problem

However, the multi-blade centrifugal air-sending device disclosed in Patent Literature 1 has backward vanes at the inner circumferences of the blades and forward vanes at the outer circumferences of the blades. This structure causes significant changes in the angles of the blade surfaces between the inner circumferences of the blades and the outer circumferences of the blades, which may newly cause airflow separation on the suction surfaces of the blades and result in a reduction in airflow.

The present disclosure is to solve such problems described above and to provide a multi-blade centrifugal air-sending device configured to prevent airflow separation on the suction surfaces of blades and thereby mitigate airflow reduction.

### Solution to Problem

A multi-blade centrifugal air-sending device according to an embodiment of the present disclosure has a fan that has a main plate that is circular-shaped when the main plate is viewed in an axial direction of a rotation axis, a plurality of blades installed around a circumferential portion of the main plate, and a side plate that is ring-shaped and fixes ends of the plurality of blades that are opposite the main plate in the axial direction of the rotation axis; and a scroll casing that has a peripheral wall that is spiral-shaped and at least one side wall that has a bell mouth that forms a suction port, the scroll casing having a discharge port through which an airflow generated by the fan is discharged, the scroll casing housing the fan. The fan has a backward vane portion that forms a backward vane of each of the plurality of blades that is located at an inner circumference of the plurality of blades in a radial direction of the fan, a forward vane portion that forms a forward vane of each of the plurality of blades that is located at an outer circumference of the plurality of blades in the radial direction of the fan, and an inflection-point portion that forms an inflection point between the backward vane portion and the forward vane portion when the inflection-point portion is viewed in the axial direction of the rotation axis. The inflection-point portion is formed over an entire length of a portion of each of the plurality of blades in the axial direction of the rotation axis. The inflection-point portion is located between a proximal end of each of the plurality of blades that is located closest to the main plate and a distal end of each of the plurality of blades that is located closest to the side plate. An entire portion of the inflection-point portion in the axial direction is positioned further inside in the radial direction of the fan than an inner circumferential end portion that forms an inner edge of the bell mouth.

### Advantageous Effects of Invention

A multi-blade centrifugal air-sending device according to an embodiment of the present disclosure has a fan that has a backward vane portion, a forward vane portion, and an inflection-point portion that forms an inflection point between the backward vane portion and the forward vane portion. The inflection-point portion is formed over an entire length of a portion of each blade of a plurality of blades in an axial direction of a rotation axis between a proximal end closest to a main plate and a distal end closest to a side plate of the blade. Also, an entire portion of the inflection-point portion in the axial direction of the rotation axis is formed such that it is positioned further inside in a radial direction of the fan than an inner circumferential end portion that forms an inner edge of the bell mouth. In a structure in which the entire portion of the inflection-point portion is positioned further inside than the inner circumferential end portion of the bell mouth, the proportion of the blade occupied by the forward vane portion is greater compared with a structure in which at least a portion or the entire portion of the inflection-point portion is positioned further outside than the inner circumferential end portion. For this reason, the multi-blade centrifugal air-sending device is designed to smooth changes in blade angles from the respective leading-edge-side portions to trailing-edge-side portions, prevent airflow separation on the suction surfaces, and thereby mitigate airflow reduction.

### BRIEF DESCRIPTION OF DRAWINGS

FIG. 1 is an external view that schematically illustrates a configuration of a multi-blade centrifugal air-sending device 1 according to Embodiment 1 with the configuration viewed parallel to a rotation axis RA.

FIG. 2 is a perspective view that illustrates the multi-blade centrifugal air-sending device according to Embodiment 1.

FIG. 3 is a perspective view that illustrates a fan of the multi-blade centrifugal air-sending device according to Embodiment 1.

FIG. 4 is a plan view that illustrates the fan of the multi-blade centrifugal air-sending device according to Embodiment 1.

FIG. 5 is a partially enlarged view that illustrates the fan of the multi-blade centrifugal air-sending device according to Embodiment 1.

FIG. 6 is a partial cross-sectional view that illustrates the multi-blade centrifugal air-sending device according to Embodiment 1.

FIG. 7 is a partial cross-sectional view that illustrates a multi-blade centrifugal air-sending device according to Embodiment 2.

FIG. 8 is a partial cross-sectional view that illustrates a multi-blade centrifugal air-sending device according to Embodiment 3.

FIG. 9 is a partially enlarged view that illustrates a fan of a multi-blade centrifugal air-sending device according to Embodiment 4.

### DESCRIPTION OF EMBODIMENTS

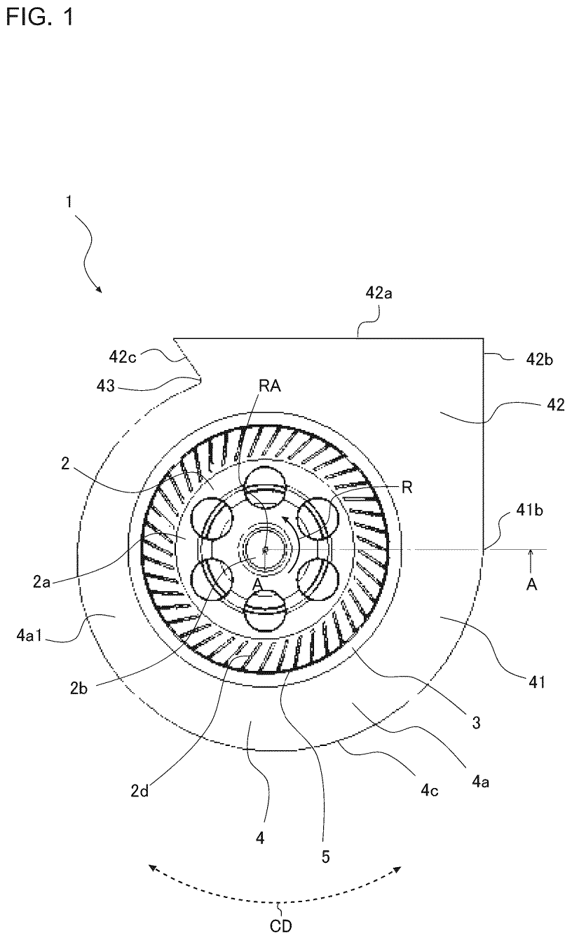

Multi-blade centrifugal air-sending devices according to embodiments are described below with reference to drawings and other reference. In addition, in the following drawings, which include FIG. 1, the relative dimensions, shapes, and other details of various components may differ from those of the actual components. Also, components given the same reference signs in the following drawings are the same as or equivalent to each other, and these reference signs are common through the full text of the specification. Also, directional terms, such as “upper”, “lower”, “right”, “left”, “front”, and “back”, used as appropriate for ease of comprehension are merely so written for convenience of explanation, and the placement or orientation of a device or a component is not limited by the directional terms.

### Embodiment 1

### Multi-Blade Centrifugal Air-sending Device 1

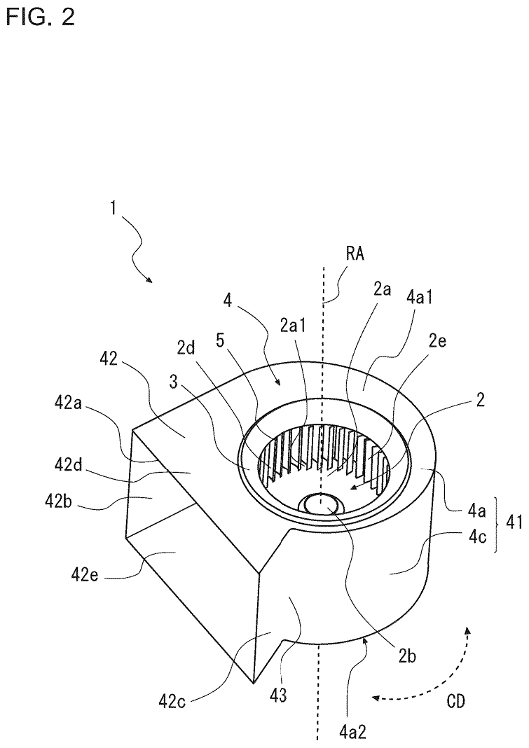

FIG. 1 is an external view that schematically illustrates a configuration of a multi-blade centrifugal air-sending device 1 according to Embodiment 1 with the configuration viewed parallel to a rotation axis RA. FIG. 2 is a perspective view that illustrates the multi-blade centrifugal air-sending device 1 according to Embodiment 1. An arrow R illustrated in FIG. 1 indicates the direction of rotation of a fan 2 and a dashed arrow CD indicates the circumferential direction of the fan 2. Also, FIG. 2 depicts the external view of the multi-blade centrifugal air-sending device 1 and simply illustrates the internal configuration of the multi-blade centrifugal air-sending device 1. The basic structure of the multi-blade centrifugal air-sending device 1 is described with reference to FIG. 1 and FIG. 2.

The multi-blade centrifugal air-sending device 1 is a device, such as a sirocco fan, that sends air by centrifugal force generated by the rotation of the fan 2. The multi-blade centrifugal air-sending device 1 is a single-suction centrifugal air-sending device through which air is sucked from one side of a scroll casing 4 in the axial direction of the virtual rotation axis RA of the fan 2. In addition, the multi-blade centrifugal air-sending device 1 is not limited to a single-suction centrifugal air-sending device and may also be a double-suction centrifugal air-sending device through which air is sucked from both sides of the scroll casing 4 in the axial direction of the rotation axis RA. The multi-blade centrifugal air-sending device 1 has, as illustrated in FIG. 1 and FIG. 2, the fan 2 configured to generate an airflow and the scroll casing 4, which houses the fan 2 inside.

### Fan 2

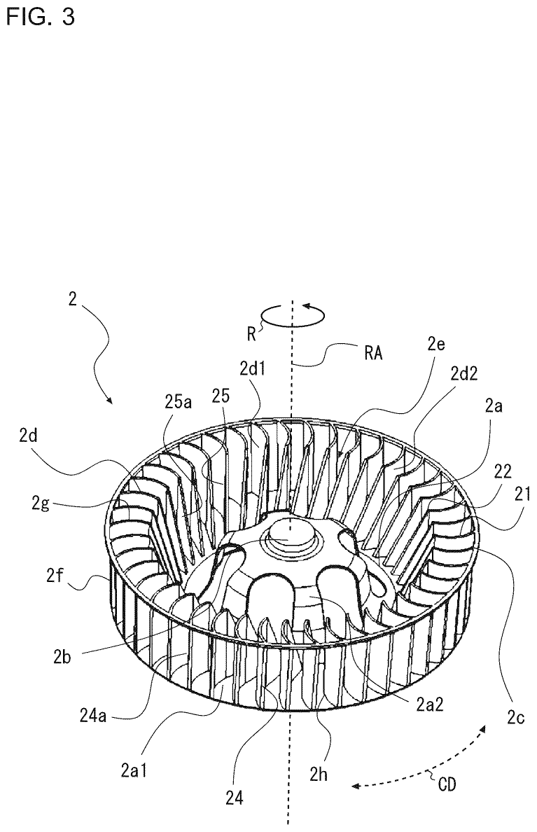

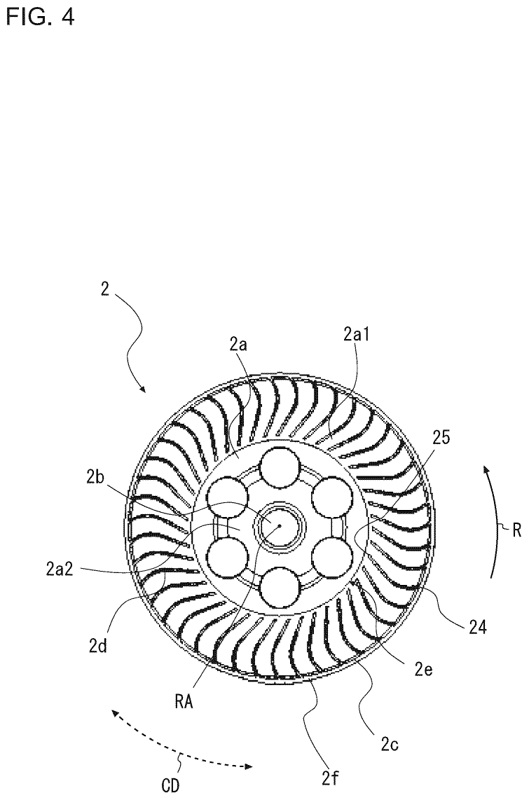

FIG. 3 is a perspective view that illustrates the fan 2 of the multi-blade centrifugal air-sending device 1 according to Embodiment 1. FIG. 4 is a plan view that illustrates the fan 2 of the multi-blade centrifugal air-sending device 1 according to Embodiment 1. In addition, FIG. 4 is a drawing that illustrates the fan 2 as viewed in the axial direction of the rotation axis RA. The fan 2 is described below with reference to FIG. 1 to FIG. 4.

The fan 2 is a centrifugal fan. The fan 2 is connected to an unillustrated motor that has a drive shaft. The fan 2 is driven by the motor into rotation. The rotation generates a centrifugal force, which causes the fan 2 to forcibly send out air outward in the radial directions. The fan 2 is driven by the motor or other drive source to rotate in the direction of rotation, which is indicated by the arrow R.

As illustrated in FIG. 1, the fan 2 has, as viewed in the direction of the rotation axis RA, a circular main plate 2a, a circular-ring-shaped side plate 2c, and a plurality of blades 2d arranged radially around the rotation axis RA, with the rotation axis RA as their center, on a circumferential portion 2a1 of the main plate 2a. The fan 2 is formed in a bottomed circular cylindrical shape by the main plate 2a and the plurality of blades 2d arranged on the main plate 2a.

The fan 2 has a fan suction port 2e formed adjacent to the side plate 2c, which is located opposite the main plate 2a in the axial direction of the rotation axis RA. The fan suction port 2e is an opening of the fan 2 through which air flows into the fan 2 and allows gas to flow into the spaces surrounded by the main plate 2a and the plurality of blades 2d.

### Main Plate 2a

The main plate 2a is formed in a circular shape as viewed in the axial direction of the rotation axis RA. The main plate 2a has the circumferential portion 2a1 formed at its outer portion and a central portion 2a2 formed at its inner portion in the radial directions centered on the rotation axis RA.

The circumferential portion 2a1 is formed further outside than the central portion 2a2 and is formed in a circular ring shape as viewed in the axial direction of the rotation axis RA. The circumferential portion 2a1 is formed in a plate shape.

The central portion 2a2 is formed further inside than the circumferential portion 2a1 and is formed such that the central portion 2a2 projects from an inner edge portion of the circumferential portion 2a1. The central portion 2a2 is formed by a plate material formed in a mountain shape. The central portion 2a2 is formed inside the plurality of blades 2d.

The circumferential portion 2a1 and the central portion 2a2 of the main plate 2a may also be integrally formed with each other. The main plate 2a may also be formed in a flat plate shape as a whole. The main plate 2a may also be formed in another shape such as a circular disc shape and a polygonal shape. The main plate 2a may also be formed such that its wall thickness increases toward its center in the radial directions centered on the rotation axis RA. Alternatively, the main plate 2a may also be formed such that its thickness is constant in the radial directions centered on the rotation axis RA. Also, the main plate 2a is not limited to a single plate material and may also be a plurality of plate materials that are integrally fixed to each other. In addition, the radial directions centered on the rotation axis RA are directions perpendicular to the axial direction of the rotation axis RA.

At the center portion of the main plate 2a, a boss portion 2b, to which the drive shaft of the motor is connected, is provided. In the boss portion 2b, a shaft hole is formed, into which the drive shaft of the motor is inserted. The boss portion 2b is formed, for example, in a circular cylindrical shape but the shape of the boss portion 2b is not limited to such a circular cylindrical shape. The boss portion 2b is only required to be formed in a pillar shape and may also be, for example, formed in a polygonal pillar shape. The main plate 2a is driven to rotate by the motor by use of the boss portion 2b.

### Side Plate 2c

The fan 2 has the ring-shaped side plate 2c attached to end portions of the plurality of blades 2d that are opposite the main plate 2a in the axial direction of the rotation axis RA. The end portions of the plurality of blades 2d that are opposite the main plate 2a are fixed to the side plate 2c in the axial direction of the rotation axis RA. The side plate 2c is provided to an outer circumferential surface 2f of the fan 2. The side plate 2c is provided to an outer portion of the blades 2d in the radial directions centered on the rotation axis RA. The side plate 2c may also be provided to distal ends 2g of the plurality of blades 2d, which project from the main plate 2a in the direction of the rotation axis RA. The side plate 2c connects the plurality of blades 2d with each other and thereby maintains the positional relationship between the tips of the blades 2d. Also, the side plate 2c thus connects the plurality of blades 2d with each other and thereby reinforces the plurality of blades 2d.

### Blades 2d

The plurality of blades 2d are installed on the circumferential portion 2a1 of the main plate 2a. The plurality of blades 2d each have one edge connected to the main plate 2a and the other edge connected to the side plate 2c and are arranged in the circumferential direction centered on the rotation axis RA. The plurality of blades 2d are each located at least between the main plate 2a and the side plate 2c. The plurality of blades 2d are arranged in a circular pattern centered on the boss portion 2b and have the base ends of the blades 2d fixed on a plate surface of the main plate 2a. As illustrated in FIG. 3, one surface of the blade 2d that faces the direction of rotation is a pressure surface 2d1 and the other surface that faces opposite to the direction of rotation is a suction surface 2d2.

Each blade 2d is located at a regular interval from another blade 2d in the circumferential direction on the circumferential portion 2a1 of the main plate 2a. Each blade 2d is provided such that it stands upright from the main plate 2a and is formed in a plate shape. Each blade 2d is provided such that it stands upright, substantially perpendicularly to the main plate 2a but is not particularly limited to this structure. Each blade 2d may also be provided such that it is inclined toward the perpendicular direction from the main plate 2a.

As illustrated in FIG. 3, the blade 2d is inclined such that a leading edge 25a is further away from the rotation axis RA from its portion adjacent to the main plate 2a to its portion adjacent to the side plate 2c. The leading edge 25a is formed by inner circumferential ends 25 of the blades 2d. The inner circumferential ends 25 are the inner ends of the blades 2d in a cross-section perpendicular to the rotation axis RA. The leading edge 25a is a portion at which the inner circumferential ends 25 are arranged in series in the axial direction of the rotation axis. The leading edge 25a of the blade 2d is inclined such that the inner diameter of the blade increases from the main plate 2a to the side plate 2c.

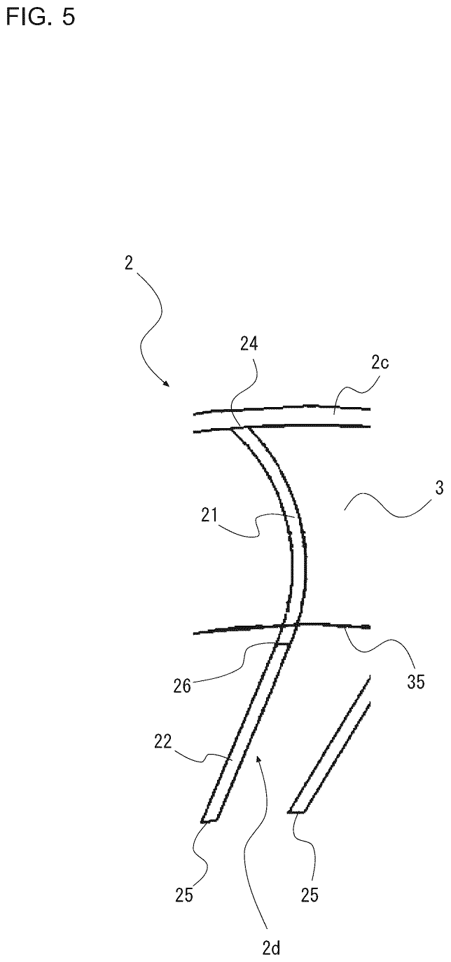

FIG. 5 is a partially enlarged view that illustrates the fan 2 of the multi-blade centrifugal air-sending device 1 according to Embodiment 1. FIG. 5 is an enlarged view that illustrates the fan 2 as viewed in the axial direction of the rotation axis RA. FIG. 5, which is intended to illustrate the shape of the blade 2d, illustrates the blade 2d as viewed through a bell mouth 3. As illustrated in FIG. 5, an inner portion of the blade 2d is formed such that it is positioned inside an inner circumferential end portion 35 of the bell mouth 3. In the blade 2d of the fan 2, as illustrated in FIG. 5, a forward vane portion 21 and a backward vane portion 22 are integrally formed with each other.

The blades 2d each have the forward vane portion 21, which includes an outer circumferential end 24 and is formed as a forward vane, and the backward vane portion 22, which includes the inner circumferential end 25 and is formed as a backward vane. Also, the blades 2d each have, as viewed in the axial direction of the rotation axis RA of the fan 2, an inflection-point portion 26, which forms the inflection point between the backward vane portion 22 and the forward vane portion 21. In the blade 2d, the backward vane portion 22, the inflection-point portion 26, and the forward vane portion 21 are integrally formed with each other in a continuous sequence in this order from the rotation axis RA toward the outer circumference in a radial direction of the fan 2.

The backward vane portion 22 is, in a radial direction of the fan 2, an inner portion of each of the plurality of blades 2d that forms the backward vane. The forward vane portion 21 is, in a radial direction of the fan 2, an outer portion of each of the plurality of blades 2d that forms the forward vane.

In the blade 2d, in which an inner portion is formed by the backward vane and an outer portion is formed by the forward vane, the inflection-point portion 26 forms the transition portion at which the backward vane portion 22 changes to the forward vane portion 21. That is, in the blade 2d, in which an inner portion is formed by the backward vane and an outer portion is formed by the forward vane, the inflection-point portion 26 forms, as viewed in the axial direction of the rotation axis RA of the fan 2, the inflection point between the backward vane portion 22 and the forward vane portion 21. In other words, the inflection-point portion 26 forms, as viewed in the axial direction of the rotation axis RA of the fan 2, the connection point between the backward vane portion 22 and the forward vane portion 21. The inflection-point portion 26 is, in the axial direction of the rotation axis RA, a portion at which the inflection points at the boundary between the backward vane portion 22 and the forward vane portion 21 are arranged in series and is also a portion at which the connection points between the backward vane portion 22 and the forward vane portion 21 are arranged in series.

The unillustrated motor drives the fan 2, which thereby rotates about the rotation axis RA as its center. When the fan 2 rotates, gas outside the multi-blade centrifugal air-sending device 1 passes through a suction port 5 formed in the scroll casing 4 and the fan suction port 2e of the fan 2, which are illustrated in FIG. 1, and is sucked into the spaces surrounded by the main plate 2a and the plurality of blades 2d. When the fan 2 rotates, air sucked into the spaces surrounded by the main plate 2a and the plurality of blades 2d then passes through the spaces between the blades 2d, which are adjacent to each other, and is sent outward in the radial directions of the fan 2.

### Scroll Casing 4

The scroll casing 4 is described below with reference to FIG. 1 to FIG. 2. The scroll casing 4 houses the fan 2 inside and rectifies air blown out from the fan 2. The scroll casing 4 is a single-suction casing that has a side wall 4a in which the suction port 5, which is described later, is formed at one side of the main plate 2a in the axial direction of the rotation axis RA. The scroll casing 4 is not limited to a single-suction casing and may also be a double-suction casing that has the side walls 4a, which have the respective suction ports 5, which are described later, at both sides of the main plate 2a in the axial direction of the rotation axis RA.

The scroll casing 4 has a scroll portion 41 and a discharge portion 42. The scroll casing 4 has a peripheral wall 4c formed in a spiral shape and the respective side walls 4a provided at both sides of the fan 2 in the axial direction of the rotation axis RA.

### Scroll Portion 41

The scroll portion 41 forms an air passage that converts the dynamic pressure of the airflow generated by the fan 2 into static pressure. The scroll portion 41 has the side walls 4a, which cover the fan 2 in the axial direction of the rotation axis RA, and the peripheral wall 4c, which surrounds the fan 2 in the radial directions of the rotation axis RA of the boss portion 2b.

Also, the scroll portion 41 has a tongue portion 43, which is positioned between the scroll portion 41 and the discharge portion 42, forms a curved surface, and guides an airflow generated by the fan 2 through the scroll portion 41 to a discharge port 42a. The internal space of the scroll portion 41, defined by the peripheral wall 4c and the side walls 4a, is a space in which air blown out from the fan 2 flows along the peripheral wall 4c.

### Side Walls 4a

In Embodiment 1, the scroll casing 4 includes the two side walls 4a. Among the two side walls 4a, a side wall 4a that has the bell mouth 3, which forms the suction port 5, is referred to as a first side wall 4a1 and a side wall 4a in which no suction port 5 and no bell mouth 3 are formed is referred to as a second side wall 4a2. The two respective side walls 4a located at both sides of the fan 2 are formed such that they face each other across the peripheral wall 4c.

The scroll casing 4 according to Embodiment 1 includes, as illustrated in FIG. 2, the first side wall 4a1 and the second side wall 4a2 as its side walls 4a. That is, the scroll casing 4 has at least one side wall 4a provided with the bell mouth 3, which forms the suction port 5, which communicates with the spaces formed by the main plate 2a and the plurality of blades 2d.

The first side wall 4a1 is a side wall 4a positioned closer to the side plate 2c than the main plate 2a. The second side wall 4a2 is a side wall 4a positioned closer to the main plate 2a than the side plate 2c. The first side wall 4a1 and the second side wall 4a2 are collectively referred to as the side wall 4a.

The first side wall 4a1 of the scroll casing 4 has the suction port 5 formed such that air is allowed to flow between the fan 2 and the outside of the scroll casing 4. The suction port 5 communicates with the fan suction port 2e and is an air-intake port that allows gas to flow into the spaces surrounded by the main plate 2a and the plurality of blades 2d. The suction port 5 is formed at a position that faces a plate surface of the main plate 2a.

The suction port 5 provided in the first side wall 4a1 is formed by the bell mouth 3. That is, the bell mouth 3 forms the suction port 5, through which a space outside the scroll casing 4 and the spaces formed by the main plate 2a and the plurality of blades 2d communicate with each other. The bell mouth 3 rectifies the flow of gas to be sucked into the fan 2 and causes the gas to flow into the fan suction port 2e of the fan 2.

The bell mouth 3 formed with an opening that has a diameter that gradually decreases from the outside toward the inside of the scroll casing 4. The bell mouth 3 is formed such that it extends in the axial direction of the rotation axis RA. The inner circumferential end portion 35, which forms the inner edge of the bell mouth 3, is positioned inside the scroll casing 4. Air around the suction port 5 smoothly flows along the bell mouth 3 and efficiently flows from the suction port 5 into the fan 2.

### Peripheral Wall 4c

The peripheral wall 4c is a wall that has a curved wall surface along which an airflow generated by the fan 2 is guided toward the discharge port 42a. The peripheral wall 4c is formed in a spiral shape. The peripheral wall 4c is formed such that, when it is viewed from the tongue portion 43 as the starting point in the direction of rotation of the fan 2, the distance from the rotation axis RA gradually increases.

The peripheral wall 4c is formed such that the clearance between the peripheral wall 4c and the outer periphery of the fan 2 expands at a predetermined rate from the tongue portion 43 to the discharge portion 42 in the direction of rotation of the fan 2 and the flow passage area for air gradually increases along the same direction as well.

The spiral shape of the peripheral wall 4c is based on, for example, a shape such as a logarithmic spiral, an Archimedean spiral, and an involute curve, The inner peripheral surface of the peripheral wall 4c forms a smooth arcuate surface along the circumferential direction of the fan 2 from the tongue portion 43, at which the spiral shape begins winding, to a winding end portion 41b, at which the spiral shape finishes winding. Such a structure allows air sent out from the fan 2 to smoothly flow through the clearance between the fan 2 and the peripheral wall 4c in the direction from the fan 2 toward the discharge portion 42. Thus, in the scroll casing 4, the static pressure of air efficiently increases from the tongue portion 43 toward the discharge portion 42.

The peripheral wall 4c is provided between the side walls 4a, which face each other, and forms the arcuate surface that extends along the direction of rotation of the fan 2. The peripheral wall 4c is located parallel to the axial direction of the rotation axis RA and covers the fan 2. In addition, the peripheral wall 4c may also be shaped such that it is inclined toward the axial direction of the rotation axis RA of the fan 2 and is not limited to being located parallel to the axial direction of the rotation axis RA.

The peripheral wall 4c forms the inner wall surface, which faces the outer circumferential surface 2f of the fan 2. The peripheral wall 4c faces the outer circumferential end portions of the plurality of blades 2d, which form the outer circumferential surface 2f of the fan 2. The peripheral wall 4c faces the side of the blades 2d of the fan 2 from which air is blown. As illustrated in FIG. 1, the peripheral wall 4c is provided from the tongue portion 43, which is a winding beginning portion at which the spiral shape begins winding, to the winding end portion 41b positioned at the boundary between the scroll portion 41 and a portion of the discharge portion 42 that is far from the tongue portion 43 along the direction of rotation of the fan 2.

The tongue portion 43 is the upstream end portion of the peripheral wall 4c, which forms the arcuate surface, in the direction in which gas is caused by rotation of the fan 2 to flow along the peripheral wall 4c in the internal space of the scroll casing 4. The winding end portion 41b is the downstream end portion of the peripheral wall 4c, which forms the arcuate surface, in the direction in which gas is caused by rotation of the fan 2 to flow along the peripheral wall 4c in the internal space of the scroll casing 4.

### Tongue Portion 43

The scroll casing 4 has the tongue portion 43, which forms the curved surface at the winding beginning portion of the peripheral wall 4c near the rotation axis RA of the fan 2 and guides the airflow generated by the fan 2 to the discharge port 42a. The peripheral wall 4c includes the tongue portion 43 at an end portion of the peripheral wall 4c that is closer to the discharge portion 42 than is the other end portion. The tongue portion 43 is formed at the winding beginning portion of the peripheral wall 4c, which is formed in a spiral shape.

The tongue portion 43 is provided at the boundary portion between the tongue portion 43 and a diffuser plate 42c of the discharge portion 42, which is described later. The tongue portion 43 is formed with the curved surface and is, as viewed in the axial direction of the rotation axis RA, formed in an arc shape. The tongue portion 43 is formed with a predetermined radius of curvature and the peripheral wall 4c is smoothly connected to the diffuser plate 42c with the tongue portion 43 in between. The tongue portion 43 is, as viewed from the discharge port 42a, in substantially the same shape in the axial direction of the rotation axis RA and is shaped along the axial direction of the rotation axis RA.

The tongue portion 43 reduces the inflow of air inside the scroll casing 4 from the end of the spiral-shaped flow passage at which its winding finishes to its beginning. The tongue portion 43 is provided upstream in the air duct and serves to separate one airflow that travels in the direction of rotation of the fan 2 from the other airflow that travels from a downstream portion in the air duct toward the discharge port 42a. Also, while the airflow is passing through the scroll casing 4, its static pressure rises to high pressure as it flows into the discharge portion 42. For this reason, the tongue portion 43 is designed to separate the pressures with such a difference. The tongue portion 43, thus designed to separate the pressures with a difference, is also designed, by its curved surface, to guide, toward each flow passage, air that is to flow into the discharge portion 42.

### Discharge Portion 42

The discharge portion 42 forms the discharge port 42a, through which an airflow that is generated by the fan 2 and has passed through the scroll portion 41 is discharged. The discharge portion 42 is formed by a hollow pipe with a rectangular cross-section perpendicular to the direction in which air flows along the peripheral wall 4c. In addition, such a cross-sectional shape of the discharge portion 42 is not limited to a rectangular shape. The discharge portion 42 forms a flow passage through which air that is sent out from the fan 2 and flows through the clearance between the peripheral wall 4c and the fan 2 is guided to be discharged to the outside of the scroll casing 4.

One end portion of the discharge portion 42 forms an unillustrated inlet port through which air flows from the scroll casing 4 into the discharge portion 42. Also, the other end portion of the discharge portion 42 forms the discharge port 42a, through which air that has passed through the flow passage inside the discharge portion 42 is discharged to outside air.

As illustrated in FIG. 2, the discharge portion 42 has an extension plate 42b, the diffuser plate 42c, a first side plate portion 42d, and a second side plate portion 42e. The extension plate 42b smoothly continues to the winding end portion 41b, which is downstream of the peripheral wall 4c, and is formed integrally with the peripheral wall 4c. The diffuser plate 42c is formed integrally with the tongue portion 43 of the scroll casing 4 and faces the extension plate 42b. The diffuser plate 42c is, for example, formed at a predetermined angle to the extension plate 42b such that a cross-sectional area of the flow passage gradually increases along the direction in which air flows inside the discharge portion 42 but is not limited to this structure.

The first side plate portion 42d is formed integrally with the first side wall 4a1 of the scroll casing 4, and the second side plate portion 42e is formed integrally with the opposite second side wall 4a2 of the scroll casing 4. In addition, the first side plate portion 42d and the second side plate portion 42e are formed between the extension plate 42b and the diffuser plate 42c. Thus, the discharge portion 42 forms a flow passage with a rectangular cross-section defined by the extension plate 42b, the diffuser plate 42c, the first side plate portion 42d, and the second side plate portion 42e.

### Relationship Between Fan 2 and Scroll Casing 4

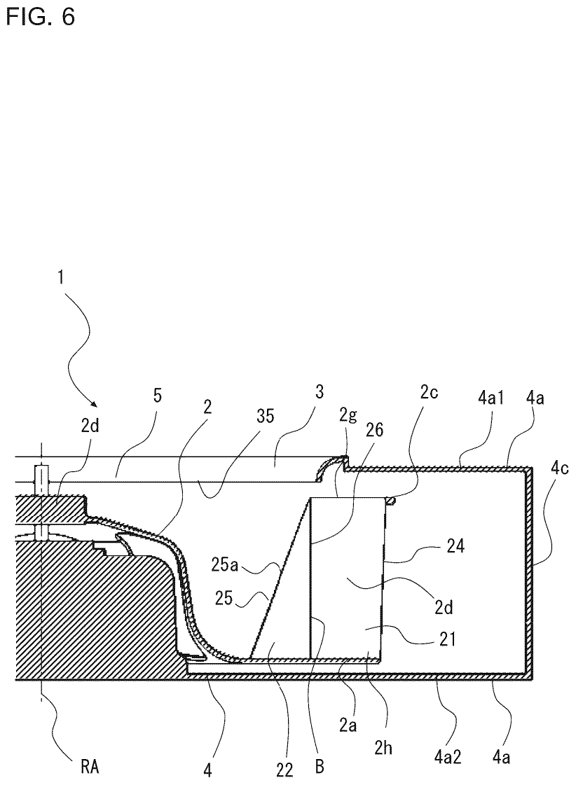

FIG. 6 is a partial cross-sectional view that illustrates the multi-blade centrifugal air-sending device 1 according to Embodiment 1. FIG. 6 is a cross-sectional view of the multi-blade centrifugal air-sending device 1 taken along the direction of arrows A-A illustrated in FIG. 1. FIG. 6 is a cross-sectional view of the multi-blade centrifugal air-sending device 1 as viewed in a radial direction of the rotation axis RA. The inflection-point portion 26 is formed over the entire length of each blade 2d. The entire length of each blade 2d is the length of the blade 2d along the axial direction of the rotation axis RA and is the length of the portion between a proximal end 2h of the blade 2d, which is located closest to the main plate 2a, and the distal end 2g of the blade 2d, which is located closest to the side plate 2c. The proximal end 2h is one end portion of the blade 2d in the axial direction of the rotation axis RA and is the end portion closest to the main plate 2a. The distal end 2g is the other end portion of the blade 2d in the axial direction of the rotation axis RA and is the end portion opposite the main plate 2a.

As illustrated in FIG. 6, the multi-blade centrifugal air-sending device 1 is, as viewed in a radial direction of the rotation axis RA, formed such that the entire portion of the inflection-point portion 26 is positioned further inside than the inner circumferential end portion 35, which forms the inner edge of the bell mouth 3. That is, as illustrated in FIG. 6, the multi-blade centrifugal air-sending device 1 is, as viewed in a radial direction of the rotation axis RA, formed such that the entire portion of the inflection-point portion 26 is positioned closer to the rotation axis RA than is the inner circumferential end portion 35 of the bell mouth 3. The multi-blade centrifugal air-sending device 1 is formed such that the entire portion of the inflection-point portion 26 in the axial direction of the rotation axis RA is positioned further inside in a radial direction of the fan 2 than the inner circumferential end portion 35, which forms the inner edge of the bell mouth 3.

The multi-blade centrifugal air-sending device 1 is formed such that an imaginary line B defined by the inflection-point portion 26, which extends from the proximal end 2h closest to the main plate 2a to the distal end 2g closest to the side plate 2c of each blade 2d, is parallel to the rotation axis RA of the fan 2. When the imaginary line B is formed parallel to the rotation axis RA of the fan 2, for example, as viewed in a radial direction of the rotation axis RA, the imaginary line B is formed at an angle to the rotation axis RA within ±1 degree.

### Operation of Multi-Blade Centrifugal Air-Sending Device 1

The operation of the multi-blade centrifugal air-sending device 1 is described with reference to FIG. 2. In the multi-blade centrifugal air-sending device 1, when an unillustrated motor drives, the main plate 2a, to which a motor shaft is connected, rotates and, through the main plate 2a, the plurality of blades 2d rotate about the rotation axis RA. Rotation of the fan 2 causes air outside the scroll casing 4 to be sucked into the scroll casing 4 through the suction port 5.

The air to be sucked into the scroll casing 4 is guided to the bell mouth 3 and sucked into the fan 2. In the process in which the air sucked into the fan 2 passes through spaces between the plurality of blades 2d, the air turns into an airflow to which dynamic pressure and static pressure are applied and the airflow is blown outward in the radial directions of the fan 2. The airflow to be blown from the fan 2 is blown from the fan 2 into the scroll casing 4 by the pressure-raising action of the fan 2.

The airflow that flows inside the scroll casing 4 is increased in pressure by flowing through the air passage, which gradually expands from the winding beginning portion toward the winding end portion by the spiral-shaped peripheral wall 4c. The air blown out from the fan 2 into the scroll casing 4 is decelerated in the expanding air passage partly formed by the peripheral wall 4c of the scroll casing 4, recovers static pressure, and is blown out to the outside from the discharge port 42a illustrated in FIG. 1.

### Mechanism and Effect of Multi-Blade Centrifugal Air-Sending Device 1

The multi-blade centrifugal air-sending device 1 has the fan 2, which has the backward vane portion 22, the forward vane portion 21, and the inflection-point portion 26, which forms the inflection point between the backward vane portion 22 and the forward vane portion 21. The inflection-point portion 26 is formed over the entire length of a portion of each of the plurality of blades 2d in the axial direction of the rotation axis RA between the proximal end 2h closest to the main plate 2a and the distal end 2g closest to the side plate 2c of the blade 2d. Also, the entire portion of the inflection-point portion 26 in the axial direction of the rotation axis RA is formed such that it is positioned further inside in the radial direction of the fan 2 than the inner circumferential end portion 35, which forms the inner edge of the bell mouth 3.

Here, a structure in which the entire portion of the inflection-point portion 26 is positioned further inside than the inner circumferential end portion 35 of the bell mouth 3 is defined as a structure A. A structure in which at least a portion or the entire portion of the inflection-point portion 26 is positioned further outside than the inner circumferential end portion 35 is defined as a structure B. In a case in which the structure A and the structure B are compared with each other for the fan 2 of the same diameter, the proportion of the blade 2d occupied by the forward vane portion 21 along the radial distance of the fan 2 is greater in the structure A compared with the structure B. For this reason, compared with the structure in which at least a portion or the entire portion of the inflection-point portion 26 is positioned further outside than the inner circumferential end portion 35, the multi-blade centrifugal air-sending device 1 is designed to smooth changes in blade angles from the respective leading edges 25a to trailing edges 24a, prevent airflow separation on the suction surfaces 2d2, and thereby mitigate airflow reduction.

Also, the fan 2 is formed such that the imaginary line B defined by the inflection-point portion 26, which extends from the proximal end 2h closest to the main plate 2a to the distal end 2g closest to the side plate 2c of each of the plurality of blades 2d, is parallel to the rotation axis RA. The multi-blade centrifugal air-sending device 1 is thus formed such that the imaginary line B is parallel to the rotation axis RA. As a result, compared with a case in which the imaginary line B is not parallel to the rotation axis RA, the fan 2 is more easily removed from the mold during the manufacture of the fan 2 and the production process is therefore simpler.

### Embodiment 2

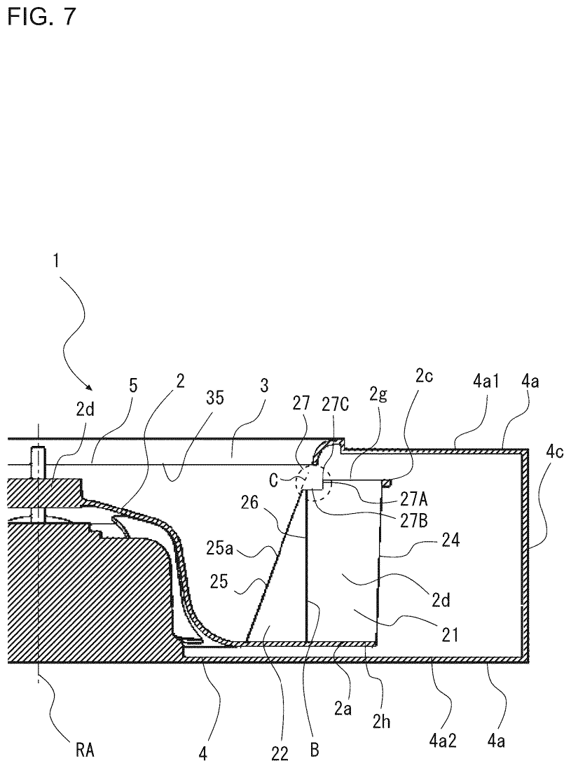

FIG. 7 is a partial cross-sectional view that illustrates a multi-blade centrifugal air-sending device 1 according to Embodiment 2. FIG. 7 is a cross-sectional view of the multi-blade centrifugal air-sending device 1 taken along the direction of arrows A-A illustrated in FIG. 1. A section that has the same structure as that of the multi-blade centrifugal air-sending device 1 illustrated in FIG. 1 to FIG. 6 is labeled with the same reference sign and its description is omitted.

The multi-blade centrifugal air-sending device 1 according to Embodiment 2 is further specified in the relationship of the shape of the blade 2d. Also, the multi-blade centrifugal air-sending device 1 according to Embodiment 2 is further specified in the positional relationship between the blade 2d and the bell mouth 3. Structures other than the shape of the blade 2d and the positional relationship between the blade 2d and the bell mouth 3 are the same as those in the multi-blade centrifugal air-sending device 1 according to Embodiment 1. Thus, the following description, with reference to FIG. 7, focuses on the structures of the blades 2d and the bell mouth 3 of the multi-blade centrifugal air-sending device 1 according to Embodiment 2.

Each blade 2d of the multi-blade centrifugal air-sending device 1 according to Embodiment 2 is formed such that a notch-shaped step portion 27 is formed at a portion of the leading edge 25a that is closest to the side plate 2c. More specifically, the blade 2d has the notch-shaped step portion 27 formed at the leading edge 25a of the blade 2d and at the distal end 2g, which is closest to the side plate 2c.

The step portion 27 is a portion formed in a state in which a wall that defines the leading edge 25a and the distal end 2g is notched. The step portion 27 is formed at a portion of the leading edge 25a and is also formed at a portion of the distal end 2g. At the step portion 27, an end portion of the leading edge 25a that is closest to the side plate 2c is notched and an end portion of the distal end 2g closest to the rotation axis RA is also notched. The step portion 27 is a portion formed in a state in which a comer portion that connects the leading edge 25a and the distal end 2g is notched. The step portion 27 is formed, as illustrated in FIG. 7, at the backward vane portion 22 and at the distal end 2g of the forward vane portion 21, which is closest to the side plate 2c.

The step portion 27 is formed by a side-portion edge portion 27A, which extends in the axial direction of the rotation axis RA of the fan 2, and an upper-portion edge portion 27B, which extends in a radial direction of the fan 2. In the fan 2, the upper-portion edge portion 27B is an edge portion positioned closer to the main plate 2a than is the distal end 2g. The fan 2 has a step formed between the upper-portion edge portion 27B and the distal end 2g in the axial direction of the rotation axis RA. Also, the fan 2 is formed such that the side-portion edge portion 27A is positioned closer to the outer periphery of the fan 2 than an imaginary extension line C of the leading edge 25a at the step portion 27. The fan 2 has the step, which is formed between the leading edge 25a and the side-portion edge portion 27A in a radial direction of the rotation axis RA.

The step portion 27 is not limited to the structure formed by the side-portion edge portion 27A, which extends in the axial direction of the rotation axis RA of the fan 2, and the upper-portion edge portion 27B, which extends in a radial direction of the fan 2. For example, the step portion 27 may also be formed as an arc-shaped edge portion in which the side-portion edge portion 27A and the upper-portion edge portion 27B are seamlessly connected and integrated with each other.

The multi-blade centrifugal air-sending device 1 according to Embodiment 2 is formed such that a blade outer diameter defined by the respective outer circumferential ends 24 of the plurality of blades 2d is larger than the inner diameter of the bell mouth 3. That is, the multi-blade centrifugal air-sending device 1 according to Embodiment 2 is, as viewed in the axial direction of the rotation axis RA, formed such that the outer circumferential ends 24 of the blades 2d are positioned further outside than the inner circumferential end portion 35 of the bell mouth 3 in a radial direction of the fan 2. Also, the multi-blade centrifugal air-sending device 1 according to Embodiment 2 is, as viewed in the axial direction of the rotation axis RA, formed such that at least portions of the leading edges 25a of the blades 2d are positioned further inside than the inner circumferential end portion 35 of the bell mouth 3 in the radial directions of the fan 2.

The boundary portion between the distal end 2g and the step portion 27 of the blade 2d is referred to as a step beginning point 27C. The step beginning point 27C of the blade 2d is the boundary portion between the distal end 2g and the side-portion edge portion 27A of the blade 2d. The step beginning point 27C is the corner portion of the blade 2d formed between the distal end 2g and the side-portion edge portion 27A. The multi-blade centrifugal air-sending device 1 according to Embodiment 2 is formed such that the step beginning points 27C of the blades 2d are positioned further outside than the inner circumferential end portion 35 of the bell mouth 3 in a radial direction of the fan 2.

As illustrated in FIG. 7, in the multi-blade centrifugal air-sending device 1 according to Embodiment 2, the inner circumferential end portion 35 of the bell mouth 3 is located above the step portion 27. The multi-blade centrifugal air-sending device 1 according to Embodiment 2 is designed such that the inner circumferential end portion 35 of the bell mouth 3 faces the step portion 27 in the axial direction of the rotation axis RA. More specifically, in the multi-blade centrifugal air-sending device 1 according to Embodiment 2, the inner circumferential end portion 35 of the bell mouth 3 is positioned such that it faces the upper-portion edge portion 27B in the axial direction of the rotation axis RA. In the multi-blade centrifugal air-sending device 1 according to Embodiment 2, a gap is formed between the inner circumferential end portion 35 of the bell mouth 3 and the upper-portion edge portion 27B.

Furthermore, in the multi-blade centrifugal air-sending device 1 according to Embodiment 2, the inner circumferential end portion 35 of the bell mouth 3 may also be positioned such that it faces the side-portion edge portion 27A in a radial direction of the fan 2. In the multi-blade centrifugal air-sending device 1 according to Embodiment 2, the gap is formed between the inner circumferential end portion 35 of the bell mouth 3 and the upper-portion edge portion 27B in the axial direction of the rotation axis RA and a gap may also be formed between the inner circumferential end portion 35 of the bell mouth 3 and the side-portion edge portion 27A in a radial direction of the rotation axis RA.

### Mechanism and Effect of Multi-Blade Centrifugal Air-Sending Device 1

Each of the plurality of blades 2d is formed such that the notch-shaped step portion 27 is formed at a portion of the leading edge 25a that is closest to the side plate 2c. In a case in which the boundary portion between the distal end 2g and the step portion 27 is defined as the step beginning point 27C, the structure is formed such that the step beginning point 27C is positioned further outside than the inner circumferential end portion 35 of the bell mouth 3 in a radial direction of the fan 2. The multi-blade centrifugal air-sending device 1 according to Embodiment 2 is designed such that, even when the height of the blade 2d is increased to expand the blade surface, the provision of the step portion 27 prevents the blade 2d from interfering with the inner circumferential end portion 35 of the bell mouth 3.

The multi-blade centrifugal air-sending device 1 is thus formed such that the step beginning points 27C are positioned further outside than the inner circumferential end portion 35 of the bell mouth 3 and is designed to increase the height of each blade 2d in the axial direction of the rotation axis RA while the interval between the inner circumferential end portion 35 of the bell mouth 3 and the blade 2d is ensured. The multi-blade centrifugal air-sending device 1 according to Embodiment 2 allows the distal ends 2g of the blades 2d to be closer to the corresponding side wall 4a compared with the blades 2d that have no step portions 27 and thereby enlarges the blade surface area and consequently obtains a large amount of airflow.

### Embodiment 3

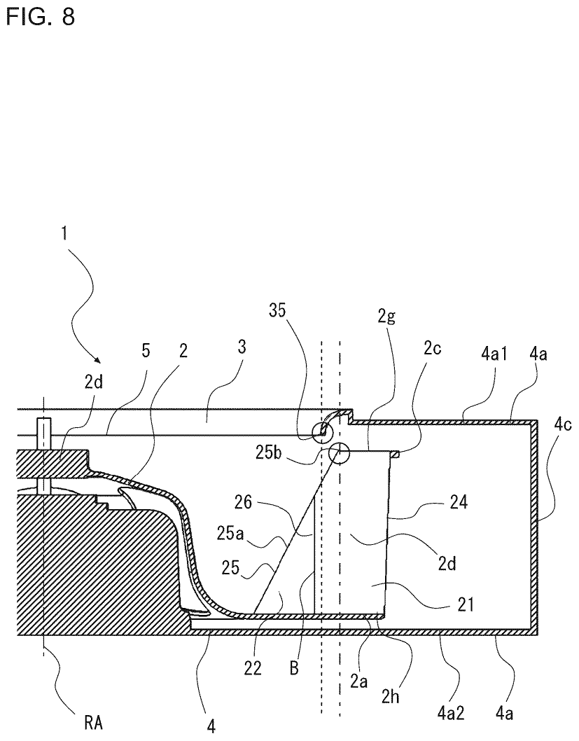

FIG. 8 is a partial cross-sectional view that illustrates a multi-blade centrifugal air-sending device 1 according to Embodiment 3. FIG. 8 is a cross-sectional view of the multi-blade centrifugal air-sending device 1 taken along the direction of arrows A-A illustrated in FIG. 1. A section that has the same structure as that of the multi-blade centrifugal air-sending device 1 illustrated in FIG. 1 to FIG. 6 is labeled with the same reference sign and its description is omitted.

The multi-blade centrifugal air-sending device 1 according to Embodiment 3 is specified in the positional relationship between each blade 2d and the bell mouth 3. Structures other than the positional relationship between the blade 2d and the bell mouth 3 are the same as those in the multi-blade centrifugal air-sending device 1 according to Embodiment 1. Thus, the following description, with reference to FIG. 8, focuses on the structures of the blades 2d and the bell mouth 3 of the multi-blade centrifugal air-sending device 1 according to Embodiment 3.

The multi-blade centrifugal air-sending device 1 according to Embodiment 3 is formed such that the blade outer diameter defined by the respective outer circumferential ends 24 of the plurality of blades 2d is larger than the inner diameter of the bell mouth 3. That is, the multi-blade centrifugal air-sending device 1 according to Embodiment 3 is, as viewed in the axial direction of the rotation axis RA, formed such that the outer circumferential ends 24 of the blades 2d are positioned further outside than the inner circumferential end portion 35 of the bell mouth 3 in a radial direction of the fan 2.

The multi-blade centrifugal air-sending device 1 according to Embodiment 3 is, as viewed in the axial direction of the rotation axis RA, formed such that portions of the leading edges 25a of the blades 2d are positioned further inside than the inner circumferential end portion 35 of the bell mouth 3 in the radial directions of the fan 2. The multi-blade centrifugal air-sending device 1 according to Embodiment 3 is, as viewed in the axial direction of the rotation axis RA, formed such that the backward vane portions 22 are positioned further inside than the inner circumferential end portion 35 of the bell mouth 3 in the radial directions of the fan 2.

In the fan 2, a portion of the leading edge 25a positioned at the boundary portion between the leading edge 25a and the distal end 2g of the blade 2d is referred to as a side-plate-side leading-edge portion 25b. The side-plate-side leading-edge portion 25b defines a portion of the comer portion of the blade 2d formed between the distal end 2g and the leading edge 25a. The multi-blade centrifugal air-sending device 1 according to Embodiment 3 is formed such that the side-plate-side leading-edge portions 25b of the blades 2d are positioned further outside than the inner circumferential end portion 35 of the bell mouth 3 in the radial directions of the fan 2. That is, the multi-blade centrifugal air-sending device 1 according to Embodiment 3 is formed such that the inner circumferential end portion 35 of the bell mouth 3 faces portions of the leading edges 25a of the blades 2d in the axial direction of the rotation axis RA.

### Mechanism and Effect of Multi-Blade Centrifugal Air-Sending Device 1

The multi-blade centrifugal air-sending device 1 according to Embodiment 3 is formed such that the side-plate-side leading-edge portions 25b are positioned further outside than the inner circumferential end portion 35 of the bell mouth 3 in the radial directions of the fan 2. The multi-blade centrifugal air-sending device 1 according to Embodiment 3 is thus formed such that the side-plate-side leading-edge portions 25b are positioned further outside than the inner circumferential end portion 35 of the bell mouth 3 and is thereby designed such that, even when the height of the blade 2d is increased to expand the blade surface, the blade 2d is prevented from interfering with the inner circumferential end portion 35 of the bell mouth 3.

The multi-blade centrifugal air-sending device 1 is thus formed such that the side-plate-side leading-edge portions 25b are positioned further outside than the inner circumferential end portion 35 of the bell mouth 3 and is designed to increase the height of each blade 2d in the axial direction of the rotation axis RA while the interval between the inner circumferential end portion 35 of the bell mouth 3 and the blade 2d is ensured. The multi-blade centrifugal air-sending device 1 allows the distal ends 2g of the blades 2d to be closer to the corresponding side wall 4a compared with the blades 2d formed such that the side-plate-side leading-edge portions 25b are positioned further inside than the inner circumferential end portion 35 of the bell mouth 3 and thereby enlarges the blade surface area and consequently obtains a large amount of airflow.

### Embodiment 4

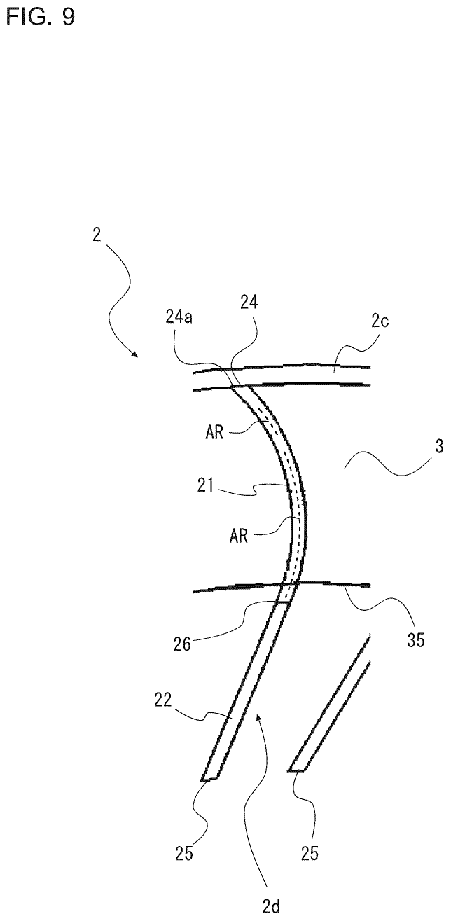

FIG. 9 is a partially enlarged view that illustrates a fan 2 of a multi-blade centrifugal air-sending device 1 according to Embodiment 4. FIG. 9 is an enlarged view that illustrates the fan 2 as viewed in the axial direction of the rotation axis RA. FIG. 9, which is intended to illustrate the shape of the blade 2d, illustrates the blade 2d as viewed through the bell mouth 3. A section that has the same structure as that of the multi-blade centrifugal air-sending device 1 illustrated in FIG. 1 to FIG. 8 is labeled with the same reference sign and its description is omitted.

The multi-blade centrifugal air-sending device 1 according to Embodiment 4 is further specified in the shape of the blade 2d. Structures other than the shape of the blade 2d, which is described below, are the same as those in the multi-blade centrifugal air-sending device 1 according to Embodiment 1. Thus, the following description, with reference to FIG. 9, focuses on the shape of the blade 2d of the multi-blade centrifugal air-sending device 1 according to Embodiment 4.

In a case in which the blade 2d is viewed in the axial direction of the rotation axis RA, a portion of the blade 2d that is formed in a circular arc shape is referred to as a circular arc portion AR. In each blade 2d of the multi-blade centrifugal air-sending device 1 according to Embodiment 4, a portion of the blade 2d from the inflection-point portion 26 to the trailing edge 24a, as referred to in FIG. 3, is formed by the single circular arc portion AR, as illustrated in FIG. 9, or by a plurality of circular arc portions AR. That is, in each blade 2d of the multi-blade centrifugal air-sending device 1 according to Embodiment 4, the forward vane portion 21 is formed by the single circular arc portion AR, as illustrated in FIG. 9, or by the plurality of circular arc portions AR. In each blade 2d of the multi-blade centrifugal air-sending device 1 according to Embodiment 4, the portion of the blade 2d from the inflection-point portion 26 to the trailing edge 24a, as referred to in FIG. 3, is formed by the at least one circular arc portion AR.

The circular arc portion AR is, as viewed in the axial direction of the rotation axis RA, a portion of the blade 2d that is formed in a circular arc shape. The trailing edge 24a is formed by the outer circumferential ends 24. The outer circumferential ends 24 are the outer ends of the blades 2d in a cross-section perpendicular to the rotation axis RA. The trailing edge 24a is a portion at which the outer circumferential ends 24 are arranged in series in the axial direction of the rotation axis.

### Mechanism and Effect of Multi-Blade Centrifugal Air-Sending Device 1

In each of the plurality of blades 2d, the portion of the blade 2d from the inflection-point portion 26 to the trailing edge 24a is formed by the at least one circular arc portion AR. The multi-blade centrifugal air-sending device 1 according to Embodiment 4 is thus designed such that the portion of each blade 2d from the inflection-point portion 26 to the trailing edge 24a is formed by the at least one circular arc portion AR and thereby reduces a steep change in the angle of the blade 2d in a radial direction of the fan 2. For this reason, the multi-blade centrifugal air-sending device 1 prevents airflow separation on the suction surfaces 2d2 and thereby mitigates airflow reduction.

Preferred embodiments and other concepts are described above in detail. Embodiments are not limited to the preferred embodiments and other concepts described above. Various formations and replacements may be applied to the preferred embodiments and other concepts described above without departing from the scope described in claims.

In the following description, various aspects of the present disclosure are listed as appendices.

Appendix 1

A multi-blade centrifugal air-sending device comprising:
a fan that has a main plate that is circular-shaped when the main plate is viewed in an axial direction of a rotation axis, a plurality of blades installed around a circumferential portion of the main plate, and a side plate that is ring-shaped and fixes ends of the plurality of blades that are opposite the main plate in the axial direction of the rotation axis; and
a scroll casing that has a peripheral wall that is spiral-shaped and at least one side wall that has a bell mouth that forms a suction port, the scroll casing having a discharge port through which an airflow generated by the fan is discharged, the scroll casing housing the fan,
the fan having
a backward vane portion that forms a backward vane of each of the plurality of blades that is located at an inner circumference of the plurality of blades in a radial direction of the fan,
a forward vane portion that forms a forward vane of each of the plurality of blades that is located at an outer circumference of the plurality of blades in the radial direction of the fan, and
an inflection-point portion that forms an inflection point between the backward vane portion and the forward vane portion when the inflection-point portion is viewed in the axial direction of the rotation axis,
the inflection-point portion being formed over an entire length of a portion of each of the plurality of blades in the axial direction of the rotation axis,
the inflection-point portion being located between a proximal end of each of the plurality of blades that is located closest to the main plate and a distal end of each of the plurality of blades that is located closest to the side plate,
an entire portion of the inflection-point portion in the axial direction being positioned further inside in the radial direction of the fan than an inner circumferential end portion that forms an inner edge of the bell mouth.

Appendix 2

The multi-blade centrifugal air-sending device described in appendix 1, in which the fan is formed such that an imaginary line defined by the inflection-point portion, which extends from the proximal end closest to the main plate to the distal end closest to the side plate of each of the plurality of blades, is parallel to the rotation axis.

Appendix 3

The multi-blade centrifugal air-sending device described in appendix 1 or 2, in which,
in each of the plurality of blades, a step portion that is notch-shaped is formed at a portion of a leading edge that is closest to the side plate, and
in a case in which a boundary portion between the distal end and the step portion is defined as a step beginning point, a structure is formed such that the step beginning point is positioned further outside than the inner circumferential end portion of the bell mouth in a radial direction of the fan.

Appendix 4

The multi-blade centrifugal air-sending device described in any one of appendices 1 to 3, in which,

in a case in which, in the fan, a portion of a leading edge positioned at a boundary portion between the leading edge and the distal end of each of the plurality of blades is defined as a side-plate-side leading-edge portion,

a structure is formed such that the side-plate-side leading-edge portion is positioned further outside than the inner circumferential end portion of the bell mouth in a radial direction of the fan.

Appendix 5

The multi-blade centrifugal air-sending device described in any one of appendices 1 to 4, in which,
in a case in which, as viewed in the axial direction of the rotation axis, a portion of each of the plurality of blades that is formed in a circular arc shape is defined as a circular arc portion,
in each of the plurality of blades, a portion of each of the plurality of blades from the inflection-point portion to a trailing edge is formed by the at least one circular arc portion.

### REFERENCE SIGNS LIST

1: multi-blade centrifugal air-sending device, 2: fan, 2a: main plate, 2a1: circumferential portion, 2a2: central portion, 2b: boss portion, 2c: side plate, 2d: blade, 2d1: pressure surface, 2d2: suction surface, 2e: fan suction port, 2f: outer circumferential surface, 2g: distal end, 2h: proximal end, 3: bell mouth, 4: scroll casing, 4a: side wall, 4a1: first side wall, 4a2: second side wall, 4c: peripheral wall, 5: suction port, 21: forward vane portion, 22: backward vane portion, 24: outer circumferential end, 24a: trailing edge, 25: inner circumferential end, 25a: leading edge, 25b: side-plate-side leading-edge portion, 26: inflection-point portion, 27: step portion, 27A: side-portion edge portion, 27B: upper-portion edge portion, 27C: step beginning point, 35: inner circumferential end portion, 41: scroll portion, 41b: winding end portion, 42: discharge portion, 42a: discharge port, 42b: extension plate, 42c: diffuser plate, 42d: first side plate portion, 42e: second side plate portion, 43: tongue portion, AR: circular arc portion, B: imaginary line

1. A multi-blade centrifugal air-sending device comprising:
a fan that has a main plate that is circular-shaped when the main plate is viewed in an axial direction of a rotation axis, a plurality of blades installed around a circumferential portion of the main plate, and a side plate that is ring-shaped and fixes ends of the plurality of blades that are opposite the main plate in the axial direction of the rotation axis; and
a scroll casing that has a peripheral wall that is spiral-shaped and at least one side wall that has a bell mouth that forms a suction port, the scroll casing having a discharge port through which an airflow generated by the fan is discharged, the scroll casing housing the fan,
the fan having
a backward vane portion that forms a backward vane of each of the plurality of blades that is located at an inner circumference of the plurality of blades in a radial direction of the fan,
a forward vane portion that forms a forward vane of each of the plurality of blades that is located at an outer circumference of the plurality of blades in the radial direction of the fan, and
an inflection-point portion that forms an inflection point between the backward vane portion and the forward vane portion when the inflection-point portion is viewed in the axial direction of the rotation axis,
the inflection-point portion being formed over an entire length of a portion of each of the plurality of blades in the axial direction of the rotation axis, the inflection-point portion being located between a proximal end of each of the plurality of blades that is located closest to the main plate and a distal end of each of the plurality of blades that is located closest to the side plate,
an entire portion of the inflection-point portion in the axial direction being positioned further inside in the radial direction of the fan than an inner circumferential end portion that forms an inner edge of the bell mouth.

2. The multi-blade centrifugal air-sending device of claim 1, wherein the fan is formed such that an imaginary line defined by the inflection-point portion, which extends from the proximal end closest to the main plate to the distal end closest to the side plate of each of the plurality of blades, is parallel to the rotation axis.

3. The multi-blade centrifugal air-sending device of claim 1, wherein,
in each of the plurality of blades, a step portion that is notch-shaped is formed at a portion of a leading edge that is closest to the side plate, and
in a case in which a boundary portion between the distal end and the step portion is defined as a step beginning point, a structure is formed such that the step beginning point is positioned further outside than the inner circumferential end portion of the bell mouth in a radial direction of the fan.

4. The multi-blade centrifugal air-sending device of claim 1, wherein,
in a case in which, in the fan, a portion of a leading edge positioned at a boundary portion between the leading edge and the distal end of each of the plurality of blades is defined as a side-plate-side leading-edge portion,
a structure is formed such that the side-plate-side leading-edge portion is positioned further outside than the inner circumferential end portion of the bell mouth in a radial direction of the fan.

5. The multi-blade centrifugal air-sending device of claim 1, wherein,
in a case in which, as viewed in the axial direction of the rotation axis, a portion of each of the plurality of blades that is formed in a circular arc shape is defined as a circular arc portion,
in each of the plurality of blades, a portion of each of the plurality of blades from the inflection-point portion to a trailing edge is formed by the at least one circular arc portion.
